(19) United States
(12) Patent Application Publication
(10) Pub. No.: US 2024/0429439 A1
(43) Pub. Date: Dec. 26, 2024

(54) SOLID-STATE STRUCTURES WITH VOLATILE SINTERING AIDS, AND METHODS FOR FABRICATION AND USE THEREOF

(71) Applicant: UNIVERSITY OF MARYLAND, COLLEGE PARK, College Park, MD (US)

(72) Inventors: Liangbing HU, Rockville, MD (US); Qi DONG, Newton, MA (US); Min HONG, Hyattsville, MD (US)

(21) Appl. No.: 18/697,032

(22) PCT Filed: Sep. 30, 2022
(86) PCT No.: PCT/US22/45326

§ 371 Date: Mar. 29, 2024

Related U.S. Application Data
(60) Provisional application No. 63/261,947, filed on Sep. 30, 2021.

(51) Int. Cl. H01M 10/0562; H01M 4/02; H01M 4/38

(52) U.S. Cl. CPC H01M 10/0562; H01M 4/382; H01M 2004/027; H01M 2300/0077

(57) ABSTRACT

A solid-state ion-conducting structure comprises a plurality of grains formed of a first material composition and a second material composition different from the first material composition. The second material composition can wet boundaries of the grains and/or fill voids between adjacent grains. Each of the material compositions can have an ionic conductivity greater than or equal to 10⁻⁴ S/cm. The second material composition may be considered a volatile sintering aid. for example. having a melting point less than a temperature at which the first material composition is sintered. In some embodiments, the solid-state ion-conducting structure can be used as a solid-state electrolyte in a battery.

### CROSS-REFERENCE TO RELATED APPLICATION

The present application claims the benefit of U.S. Provisional Application No. 63/261,947, filed Sep. 30, 2021, entitled “Solid-State Electrolyte Materials with Volatile Sintering Aids and Methods of Making and Using the Same,” which is incorporated by reference herein in its entirety.

### FIELD

The present disclosure relates generally to solid-state structures, and more particularly, to solid-state ion-conducting structures formed within and/or comprising volatile sintering aids.

### BACKGROUND

Solid-state electrolytes (SSEs) formed by ion-conducting ceramics have been contemplated for use in next generation lithium (Li) ion battery technologies, for example, to provide enhanced safety and higher energy densities. To this end, a range of ceramic SSEs have been developed, such as but not limited to perovskite-type Li₃ₓLa_{2/3-x}TiO₃, NASICON-type Li_{1.3}Al_{0.3}Ti_{1.7}(PO₄)₃ and Li₁₊ₓAlₓGe₂₋ₓ(PO₄)₃, garnet-type Li₇La₃Zr₂O₁₂ (LLZO) and their derivatives. Such ceramic SSEs can exhibit high ionic conductivity (e.g., up to 10⁻³ S/cm), a wide electrochemical window (e.g., up to 6 V), good chemical stability (e.g., against Li metal), and excellent mechanical properties (e.g., mechanical strength up to 20 GPa). However, the adoption of SSEs for all-solid-state batteries has been hindered due to fabrication issues. For example, the presence of voids, gaps, pinholes, or other defects in the SSEs after sintering can make the sintered SSEs vulnerable to penetration by Li dendrites, leading to thermal runaway, fire, or even explosion. This vulnerability can be particularly problematical when operating battery cells at medium-to-high current densities and/or over long durations. Previous efforts have attempted to address these fabrication issues by relying on inorganic filters or sintering aids. However, the prolonged heating at high temperatures required by conventional sintering techniques results in the decomposition, melting, and/or sublimination of many promising fillers or sintering aids, thereby limiting the class of available materials and performance of the sintered structures. Embodiments of the disclosed subject matter may address one or more of the above-noted problems and disadvantages, among other things.

### SUMMARY

Embodiments of the disclosed subject matter system provide sintering methods that can be used to form solid-state ion-conducting structures with sintering aids or fillers, as well as solid-state ion-conducting structures incorporating such sintering aids or fillers. In some embodiments, the sintering aid or filler is volatile (e.g., having a melting point less than a temperature at which a base material or matrix of the ion-conducting structure is sintered, for example, a melting point less than 1200 K), but has a high ionic conductivity (e.g., ≥10⁻⁶ S/cm, for example, ≥10⁻⁴ S/cm) and a low electronic conductivity (e.g., ≤10⁻¹⁰ S/cm, for example, ≤10⁻¹¹ S/cm). For example, in some embodiments, the solid-state ion-conducting structure can be formed and used as a solid-state electrolyte (SSE) in a battery. In some embodiments, the solid-state ion-conducting structure exhibits a higher relative density (e.g., >93%), a higher ionic conductivity, and/or a lower electronic conductivity as compared to conventionally-sintered structures and/or pristine material without any sintering aid or filler.

In one or more embodiments, a solid-state ion-conducting structure can comprise a plurality of grains formed of a first material composition. The solid-state ion-conducting structure can further comprise a second material composition different from the first material composition. The second material composition can wet boundaries of the plurality of grains and/or fill voids between adjacent grains. Each of the first and second material compositions can have an ionic conductivity greater than or equal to approximately 1×10⁻⁴ S/cm. A melting point of the first material composition can be greater than or equal to a first temperature, and a melting point of the second material composition can be less than the first temperature.

In one or more embodiments, a battery can comprise an anode, a cathode, and a solid-state electrolyte separating the anode from the cathode. The solid-state electrolyte can comprise a plurality of grains formed of a first material composition. The solid-state electrolyte can further comprise a second material composition different from the first material composition. The second material composition can wet boundaries of the plurality of grains and/or fill voids between adjacent grains. Each of the first and second material compositions can have an ionic conductivity greater than or equal to approximately 1×10⁻⁴ S/cm. A melting point of the first material composition can be greater than or equal to a first temperature, and a melting point of the second material composition can be less than the first temperature.

In one or more embodiments, a method can comprise providing a first powder. The first powder can comprise a first material composition or one or more first precursors of the first material composition. A melting point of the first material composition can be greater than or equal to a first temperature. The method can further comprise providing a second powder. The second powder can comprise a second material composition or one or more second precursors of the second material composition. The second material composition can be different from the first material composition. A melting point of the second material composition can be less than the first temperature. The method can also comprise forming a composite pellet by at least mixing the first and second powders together. The method can further comprise subjecting the composite pellet to a high-temperature heating pulse so as to convert the composite pellet into a solid-state ion-conducting structure. The high-temperature heating pulse can comprise exposure to a first sintering temperature of at least 600 K for a duration less than or equal to 60 seconds. Within the solid-state ion-conducting structure, the second material composition can wet boundaries of a plurality of grains formed by the first material composition and/or fill voids between adjacent grains formed by the first material composition. Each of the first and second material compositions can have an ionic conductivity greater than or equal to approximately 1×10⁻⁴ S/cm.

In one or more embodiments, a method can comprise providing an initial pellet, which can comprise a first material composition or one or more first precursors of the first material composition. A melting point of the first material composition can be greater than or equal to a first temperature. The method can further comprise heating the initial pellet at a second sintering temperature to form a sintered structure. The sintered structure can comprise a plurality of grains formed by the first material composition. The method can also comprise coating a surface of the sintered structure with a second material composition or one or more second precursors of the second material composition. The second material composition can be different from the first material composition. A melting point of the second material composition can be less than the first temperature. The method can also comprise subjecting the coated sintered structure to a high-temperature heating pulse so as to convert the coated sintered structure into a solid-state ion-conducting structure. The high-temperature heating pulse can comprise exposure to a first sintering temperature of at least 600 K for a duration less than or equal to 60 seconds. Within the solid-state ion-conducting structure, the second material composition can wet boundaries of the plurality of grains and/or fill voids between adjacent grains. Each of the first and second material compositions can have an ionic conductivity greater than or equal to approximately 1×10⁻⁴ S/cm.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a simplified view of an ionic conductor with a volatile filler, according to one or more embodiments of the disclosed subject matter.

FIG. 1B is a simplified view of a battery employing a solid-state electrolyte (SSE) with volatile filler, according to one or more embodiments of the disclosed subject matter.

FIG. 2A is a simplified schematic diagram of single stage sintering for forming an ionic conductor with a volatile filler, according to one or more embodiments of the disclosed subject matter.

FIG. 2B is a process flow diagram of an exemplary method for forming an ionic conductor via single stage sintering, according to one or more embodiments of the disclosed subject matter.

FIG. 3A is a simplified schematic diagram of two-stage sintering for forming an ionic conductor with a volatile filter, according to one or more embodiments of the disclosed subject matter.

FIG. 3B is a process flow diagram of an exemplary method for forming an ionic conductor via two-stage sintering, according to one or more embodiments of the disclosed subject matter.

FIG. 4A is a graph illustrating an exemplary temperature profile for sintering via high temperature heating pulse, according to one or more embodiments of the disclosed subject matter.

FIG. 4B depicts a generalized example of a computing environment in which the disclosed technologies may be implemented.

FIG. 5A is a scanning electron microscopy (SEM) image of the fractured surface of a fabricated LLZTO SSE with Li₃N filler.

FIGS. 5B-5C are higher magnification SEM images of the fractured surface of the fabricated SSE of FIG. 5A.

FIG. 5D are elemental mapping images of the fractured surface of the fabricated SSE of FIG. 5A.

FIG. 5E are elemental mapping images of an outer surface of the fabricated SSE of FIG. 5A.

FIGS. 6A-6B are SEM images of the fractured surface of a fabricated LLZTO SSE with Li₃N filler at a content of 2 wt %.

FIGS. 6C-6D are SEM images of the fractured surface of a fabricated LLZTO SSE with Li₃N filler at a content of 3 wt %.

FIGS. 6E-6G are SEM images of the fractured surface of a fabricated LLZTO SSE with Li₃N filler at a content of 5 wt %.

FIG. 7A shows results (on a logarithmic scale) of X-ray powder diffraction (XRD) analysis of fabricated LLZTO SSE membranes with and without Li₃N filler, as compared to the standard diffraction pattern of Li_{6.5}La₃Zr_{1.45}Ta_{0.55}O₁₂.

FIG. 7B shows results of thermogravimetric analysis (TGA) of fabricated LLZTO SSE membranes with and without Li₃N filler.

FIGS. 7C-7F show X-ray photoelectron spectroscopy (XPS) results of nitrogen (N) 1 s, lithium (Li) 1 s, oxygen (O) 1 s, and zirconium (Zr) 1 s, respectively, for the LLZTO SSE membrane with Li₃N filler.

FIG. 8A shows ionic conductivities as measured by electrochemical impedance spectroscopy (EIS) of fabricated LLZTO SSE membranes with and without Li₃N filler.

FIG. 8B shows measured activation energies of fabricated LLZTO SSE membranes with and without Li₃N filler.

FIG. 8C shows measured electronic conductivities of fabricated LLZTO SSE membranes with and without Li₃N filler.

FIG. 8D shows results of critical current density (CCD) tests for symmetric cells including LLZTO SSE membranes with and without Li₃N filler.

FIGS. 9A-9B show results of galvanostatic cycling tests at 0.2 mA/cm² and 0.5 mA/cm², respectively, of symmetric cells including LLZTO SSE membranes with and without Li₃N filler.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.

High-temperature Heating Pulse: Application of a sintering temperature for a time period having a duration less than or equal to about 60 seconds. In some embodiments, the duration of the time period of heating pulse application is less than 30 seconds, for example, less than or equal to 20 seconds. For example, in some embodiments, the duration of the heating pulse can be in a range of about 10 seconds to about 20 seconds, inclusive. In some embodiments, the heating pulse may involve heating to the sintering temperature at a ramp rate of at least 10³ K/s (e.g., about 10⁵ K/s) prior to the sintering time period, and/or cooling from the sintering temperature at a ramp rate of at least 10³ K/s (e.g., about 10⁵ K/s).

Sintering temperature: A peak or maximum temperature at a surface of one or more heating elements when energized (e.g., by application of a current pulse) and/or at a surface of a material being heated. In some embodiments, the sintering temperature is at least about 600 K, for example, at least 1000 K. In some embodiments, the sintering temperature is at least 1200 K, for example, in a range of about 1500 K to about 3000 K, inclusive. In some embodiments, the sintering temperature is a maximum temperature experienced by a volatile sintering aid or filler, but which is otherwise insufficient to cause sintering of a base material or matrix (e.g., a temperature in a range of 600-1000 K, inclusive), for example, when the sintering aid or filler is melted for incorporation into a previously-sintered structure formed by the matrix. In some embodiments, a temperature at a material being sintered (e.g., precursors on a substrate) can match or substantially match (e.g., within 10%) the temperature of the heating element.

Grain: In a crystalline solid, a region of multiple particles having an uninterrupted crystal structure. The interface between two grains in the crystalline solid forms a grain boundary.

Grain size: A cross-sectional dimension (e.g., diameter) of crystals within a crystalline solid (e.g., a sintered ceramic material, such as an ionic conductor). In some embodiments, an identified grain size represents an average size for all grains (e.g., an average of the maximum cross-sectional dimensions). In some embodiments, the grain size can be measured according to one or more known standards, such as, but not limited to, ASTM E112-13, entitled “Standard Test Methods for Determining Average Grain Size” and published Nov. 17, 2021, and ISO 643:2019, entitled “Steels—Micrographic Determination of the Apparent Grain Size” and published March 2020, all of which are incorporated by reference herein.

NASICON: Sodium-based super ionic conductors, for example, having a chemical formula of Na₁₊ₓZr₂SiₓP₃₋ₓO₁₂, where 0<x<3. In some embodiments, Zr, Si, and/or Na in the chemical formula can be replaced by an isovalent element, such as V. Sb, or Ta.

LISICON: Lithium-based super ionic conductor, for example, having a chemical formula of Li₂₊₂ₓZn₁₋ₓGeO₄.

Relative Density: The ratio of the measured density of a sintered structure to the theoretical maximum density of the primary material (e.g., first material composition) of the sintered structure.

Grain Boundary Wetting: The coating of grain boundaries of a first material composition in a sintered structure by a second material composition different from the first material composition. In some embodiments, the second material composition has a melting temperature less than that of the first material composition, and/or the second material composition has an electronic conductivity less than that of the first material composition.

### Introduction

Disclosed herein are composite solid-state structures formed by sintering and incorporating fillers (also referred to herein as sintering aids) therein, which composite structures would otherwise be unattainable by conventional sintering techniques due to volatility of the fillers. In embodiments, the fillers can be incorporated using a high-temperature heating pulse (e.g., ≤60 s in duration), enabled at least in part by fast temperature ramping and/or cooling rates (e.g., ≥10³ K/s). Due to the short duration of applied heating (e.g., seconds as opposed to the several hours required by conventional sintering), fillers will not decompose or severely volatilize, and a dense composite structure can be obtained. Accordingly, the candidate space of available fillers for incorporation can be expanded, and an appropriate filler can be selected to enhance performance of the composition structure for a particular application.

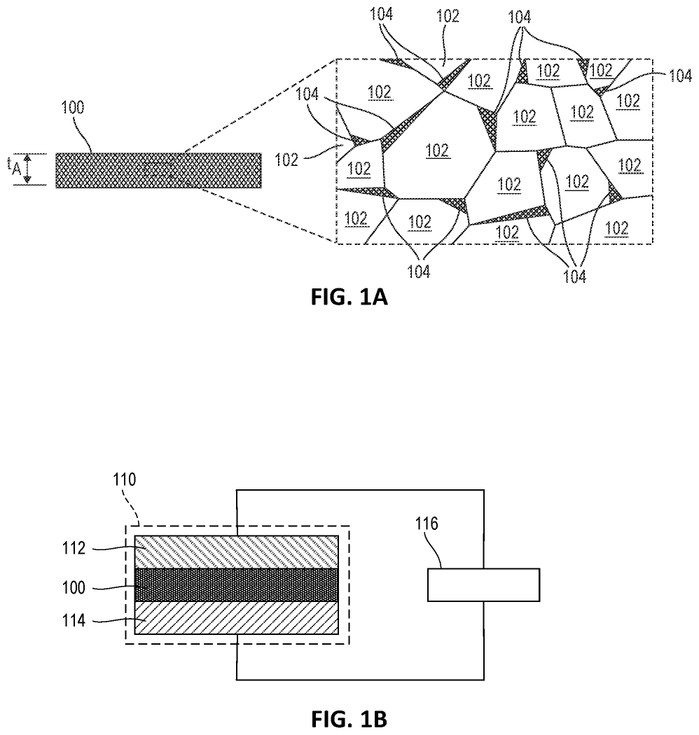

In some embodiments, the composite solid-state structure can be formed as an ion conductor, for example, to conduct metal ions (e.g., alkali metal ions, such as lithium (Li) ions, sodium (Na) ions, potassium (K) ions, etc., and/or alkaline earth metal ions, such as magnesium (Mg)) or anions (e.g., oxygen (O) ions). Referring to FIG. 1A, an exemplary configuration of a composite solid-state material as an ion-conducting structure 100 is shown. The ion-conducting structure 100 can comprise and/or be formed of (i) one or more first material compositions (e.g., ceramic) that acts as a base material or matrix of the structure and (ii) one or more second material compositions that act as a filler of the structure. For example, the first material composition can comprise a ceramic, and the second material composition can comprise an inorganic metal salt or a non-oxide metal salt. In some embodiments, the second material composition may constitute no more than 5 wt % of the ion-conducting structure 100, for example, less than or equal to 2 wt % (e.g., ˜1 wt %).

The first material composition can have a melting temperature and/or a sintering temperature greater than the melting temperature of the second material composition. For example, the first material composition can have a melting temperature and/or sintering temperature greater than 1200 K, while the second material composition can have a melting temperature less than 1200 K (e.g., a melting point in a range of 500-1100 K). Thus, when the first material composition is subjected to a temperature to effect sintering thereof, the second material composition would be susceptible to loss via melting, decomposition, and/or sublimination. However, such loss can be avoided, or at least reduced, by employing the high-temperature heating pulse techniques disclosed herein.

After sintering, the microstructure of the ion-conducting structure 100 can exhibit a plurality of grains 102 formed by the first material composition, with the second material composition 104 wetting the grains 102 and/or filling voids (e.g., pinholes, gaps, or any other interstices) between adjacent grains 102. In some embodiments, the grains 102 of the first material composition can have a size less than or equal to 10 μm, for example, in a range of 1-5 μm, and/or the voids can have a size that is sub-micron (e.g., <1 μm). By filling at least some of the voids between adjacent grains 102, the second material composition 104 can allow the structure 100 to achieve a higher relative density than otherwise possible without the filler, for example, greater than 93% (e.g., ˜95% relative density). Alternatively or additionally, in some embodiments, by filling at least some of the voids between adjacent grains 102, the second material composition 104 can allow the structure 100 to exhibit improved mechanical properties (e.g., a mechanical strength ≥10 MPa).

In some embodiments, for example, when the ion-conducting structure is used as a solid-state electrolyte (SSE) for a battery, the first and second material compositions can be selected such that the resulting ion-conducting structure 100 has a high ionic conductivity (e.g., ≥˜1×10⁻³ S/cm) and a low electronic conductivity (e.g., ≤1×10⁻⁸ S/cm, such as ˜2×10⁻⁹ S/cm). For example, the first material composition and/or the second material composition can have an ionic conductivity of at least 1×10⁻⁴ S/cm. Alternatively or additionally, the first material composition and/or the second material composition can have an electronic conductivity of 1×10⁻⁸ S/cm or less. In some embodiments, the second material composition can have an electronic conductivity that is less than that of the first material composition, for example, at least one order of magnitude less than that of the first material composition. For example, in some embodiments, the second material composition has an electronic conductivity no greater than 1×10⁻¹⁰ S/cm (e.g., less than or equal to 10⁻¹¹ S/cm, such as 10⁻¹² S/cm), and the first material composition has an electronic conductivity no greater than 1×10⁻⁸ S/cm (e.g., ≤10⁻⁹).

In some embodiments, the first material composition, the second material composition, or both can include the element corresponding to the desired ion to be conducted, among other constituent elements. For example, when the ion-conducting structure is used as an SSE for an Li ion battery, the first material composition and/or the second material composition can comprise Li. In some embodiments, the first material composition can satisfy a chemical formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, where 4<A<8.5, 1.5<B<4, 0≤C≤2, 0≤D≤2, 0≤E<2, and 10<F<13, M′ is a first one selected from Al, Mo, W, Nb, Sb, Ca, Ba, Sr, Ce, Hf, Rb, or Ta, and M″ is a second one selected from Al, Mo, W, Nb, Sb, Ca, Ba, Sr, Ce, Hf, Rb, or Ta. Alternatively, is some embodiments, the first material composition can satisfy a chemical formula of Li_{A}La_{B}Zr_{C}Al_{D}M′″_{E}O_{F}, where 5<A<7.7, 2<B<4, 0<C≤2.5, 0≤D<2, 0≤E<2, and 10<F<13, and M′″ is Nb, Ta, V, W, Mo, or Sb. For example, the SSE formed by sintering of the first material composition can be selected from the group consisting of perovskite-type Li₃ₓLa_{2/3-x}TiO₃, NASICON-type Li_{1.3}Al_{0.3}Ti_{1.7}(PO₄)₃, NASICON-type Li₁₊ₓAlₓGe₂₋ₓ(PO₄)₃, garnet-type Li₇La₃Zr₂O₁₂ (LLZO), garnet-type Li₇La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, and anti-perovskite-type Li₃OCl. The properties of such exemplary SSE materials are provided below in Table 2.

In some embodiments, the second material composition can be a composition that lacks any oxygen and has an electronic conductivity no greater than 10⁻¹² S/cm. Alternatively or additionally, in some embodiments, the second material composition can be a composition that lacks any oxygen and has an electronic conductivity no greater than 10⁻¹⁰ S/cm. For example, the second material composition can be selected from the group consisting of LiCl, LiBr, LiI, LiF, Li₃N, LiBH₄, and LiBF₄. Alternatively, in some embodiments, the second material composition can be a composition that includes oxygen. For example, the second material composition can be Li₃BO₃ or Li₃PO₄. The properties of such exemplary filler materials are provided below in Table 1.

Although Tables 1 and 2 and the description above has mentioned specific material compositions, embodiments of the disclosed subject matter are not limited thereto. Rather, other material compositions are also possible according to one or more contemplated embodiments, for example, to accommodate different ions for conduction, to provide different performance metrics (e.g., higher ionic conductivity and/or lower electronic conductivity), to provide different fabrication limits (e.g., different melting points and/or sintering temperatures), to provide different mechanical properties (e.g., mechanical strength), or for any other reason.

As mentioned above, in some embodiments, the ion-conducting structure 100 of FIG. 1A can be used an SSE in a battery (e.g., primary battery or secondary battery), such as battery 110 of FIG. 1B. The battery 110 can include an anode 112 and a cathode 114 disposed on opposite sides of the ion-conducting structure 100 (e.g., having a thickness t₁ less than or equal to 1 mm, for example, in a range of 200-1000 μm). In some embodiments, the anode 112 and/or cathode 114 can be formed separate from the ion-conducting structure 100 and subsequently coupled thereto to form battery 110. Alternatively or additionally, in some embodiments, the anode 112 and/or cathode 114 can be integrally formed on the ion-conducting structure 100 or with the ion-conducting structure 100, for example, via the sintering method disclosed in International Publication No. WO 2020/236767, published Nov. 26, 2020 and entitled “High temperature sintering systems and methods,” which is incorporated herein by reference.

Through the anode 112 and cathode 114, the battery 110 may be coupled via an appropriate electrical circuit to node 116, which may be an electrical load for use of charge stored by the battery or a power source for recharging the battery. In some embodiments, the battery 110 can be a Li ion battery. For example, anode 112 can be formed of solid Li metal. The use of the second material composition to fill voids between grains in the ion-conducting structure 100 can result in a dense microstructure that, together with the high ionic conductivity and low electronic conductivity of the second material composition, improves electrochemical performance of the battery and/or prevents (or at least reduces) Li dendrite penetration through the SSE. For example, battery 110 can exhibit a critical current density (CCD) of at least 2 mA/cm², an areal specific resistance (ASR) less than or equal to 50 Ω·cm² (e.g., ˜35 Ω·cm²), and/or an electrochemical stability window of at least 4 V.

### Tables of Material Composition Properties

TABLE 1
Exemplary second material compositions for fillers.

| | | | Ionic | Electronic | |
|---|---|---|---|---|---|
| | | Melting | Conductivity | Conductivity | |
| | Compo- | Point | at ambient | at ambient | Density |
| Category | sition | (K) | (S/cm) | (S/cm) | (g/cm³) |
| A | LiBH₄ | 541 | ~1 × 10⁻⁴ | <10⁻¹² | 0.7 |
| A | LiBF₄ | 570 | ~1 × 10⁻⁴ | <10⁻¹² | 0.9 |
| A | Li₃N | 1086 | ~1 × 10⁻³ | <10⁻¹² | 1.3 |
| B | LiF | 1121 | ~1 × 10⁻⁶ | <10⁻¹¹ | 2.6 |
| C | LiCl | 878 | ~5 × 10⁻⁴ | <10⁻¹⁰ | 2.1 |
| C | LiBr | 825 | ~1.7 × 10⁻³ | <10⁻¹⁰ | 3.5 |
| C | LiI | 732 | ~1 × 10⁻⁴ | <10⁻¹⁰ | 3.5 |
| D | Li₃BO₃ | 1033 | ~1 × 10⁻⁵ | <10⁻¹⁰ | 2.2 |
| D | Li₃PO₄ | 1110 | ~1 × 10⁻⁷ | <10⁻¹⁰ | 2.5 |

A: Non-oxygen-containing composition with electronic conductivity ≤10⁻¹² S/cm;
B: Non-oxygen-containing composition with electronic conductivity ≤10⁻¹¹ S/cm;
C: Non-oxygen-containing composition with electronic conductivity ≤10⁻¹⁰ S/cm; and
D: Oxygen-containing composition with electronic conductivity ≤10⁻¹⁰ S/cm.

TABLE 2
Exemplary first material compositions for ionic conductors.

| | | Ionic | Electronic |
|---|---|---|---|
| | Sintering | Conductivity | Conductivity |
| | Point | at ambient | at ambient |
| Composition | (K) | (S/cm) | (S/cm) |
| Li₃ₓLa_{2/3-x}TiO₃ | 1573 | ~6 × 10⁻⁴ | <10⁻⁸ |
| Li_{1.3}Al_{0.3}Ti_{1.7}(PO₄)₃ | 1373 | ~6 × 10⁻⁴ | <10⁻⁸ |
| Li₁₊ₓAlₓGe₂₋ₓ(PO₄)₃ | 1173 | ~3 × 10⁻⁴ | <10⁻⁹ |
| Li₇La₃Zr₂O₁₂ | 1473 | ~1 × 10⁻³ | <10⁻⁸ |
| Li₆PS₅Cl | 873 | ~2 × 10⁻³ | <10⁻⁹ |
| Li₁₄Zn(GeO₄)₄ | 1073 | ~1 × 10⁻⁶ | <10⁻⁹ |
| Li₄₋ₓGe₁₋ₓPₓS₄ | 823 | ~1 × 10⁻² | <10⁻⁹ |
| Li₃OCl | 623 | ~1 × 10⁻³ | <10⁻¹⁰ |

### Single-Stage Sintering Methods

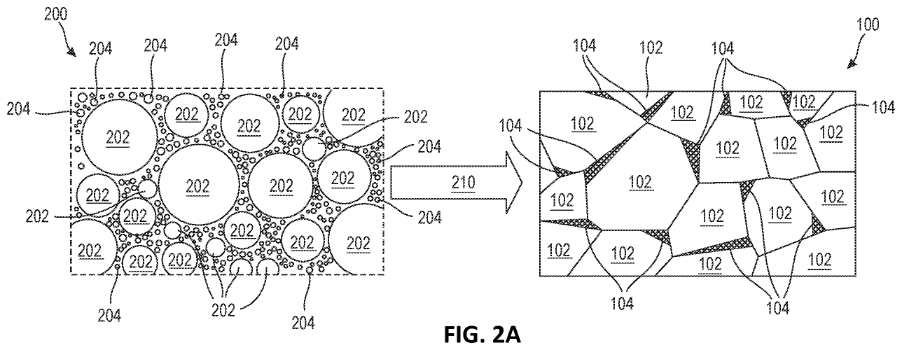

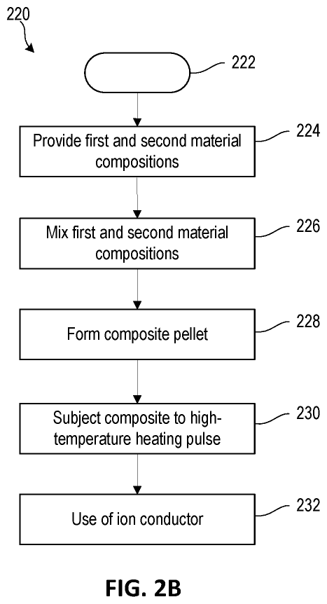

FIG. 2A illustrates aspects of an exemplary single-stage sintering process. An initial composite green pellet 200 can be provided, for example, by disposing and/or pressing together powders of different material compositions. In the illustrated example, the green pellet 200 has a plurality of larger particles 202 formed by one or more first material compositions (and/or precursors thereof), and a plurality of smaller particles 204 formed by one or more second material compositions (and/or precursors thereof). By subjecting the pellet 200 to a high-temperature heating pulse 210 (e.g., having a duration ≤60 seconds), the pellet 200 can be converted to the composite ion-conducting structure 100, for example, by sintering particles 202 together to form grains 102 of the first material composition while particles 204 of the second material composition melt. In some embodiments, the peak temperature of the heating pulse can render an accelerated sintering rate with surface energy being the main driving force, where particles of the first material composition can form “neck bonding.” Alternatively or additionally, the liquid phase of the second material composition can help to rearrange particles of the first material composition, for example, via capillary pressure, which may help to further reduce porosity of the final structure. Because of the short exposure to high temperature, the second material composition, which could otherwise be lost to decomposition or evaporation, can be retained in the final structure. After termination of the heating pulse and subsequent cooling, the second material composition 104 solidifies as a coating on the grains 102 and/or filling voids between grains 102 that lack neck connection. The retained second material composition densifies the final structure by removing voids between grains of the first material composition and/or healing other defects.

Referring to FIG. 2B, a method 220 for fabricating a composite sintered structure using single stage sintering is shown. The method 220 can initiate at terminal block 222 and proceed to process block 224, where one or more first material compositions (or precursors thereof) and one or more second material compositions (or precursors thereof) can be provided. In some embodiments, the first and second material compositions can be provided in powder form. For example, the provision of process block 224 can include ball-milling and/or calcination. The method 220 can proceed to process block 226, where the first and second material compositions (or precursors thereof) can be mixed together. For example, the mixing of process block 226 can comprise trituration, conical mixing, impact mixing, and/or shear mixing. The method 220 can proceed to process block 228, where the mixture of the first and second material compositions (or precursors thereof) can be formed into a composite pellet. In some embodiments, the composite pellet can be formed by pressing and/or molding, such as by using a pelletizing disk or drum. For example, the mixture can be pressed using a metal die (e.g., stainless steel) into green pellets (e.g., un-sintered disks having a diameter of ˜10 mm and a thickness of ˜550 μm).

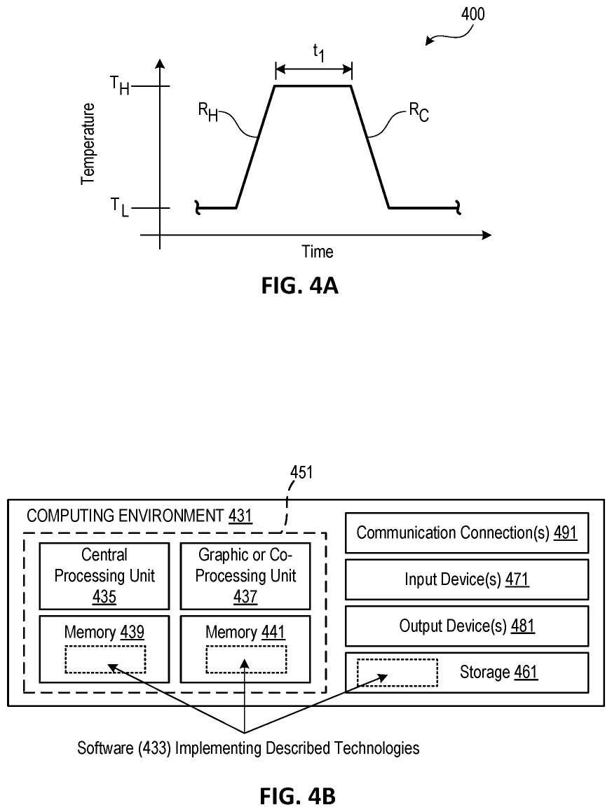

The method 220 can proceed to process block 230, where the composite pellet is subjected to one or more high-temperature heating pulses so as to covert the mixture into a solid-state ion conductor. In some embodiments, the heating pulse includes a peak temperature greater than a sintering temperature of the first material composition for a duration less than or equal to 60 seconds, after which the heating can be removed and the pellet allowed to cool to ambient temperature, for example, as shown in FIG. 4A and described in further detail below. In some embodiments, the peak temperature of the heating pulse can be greater than a melting temperature of the second material composition, but less than a melting temperature of the first material composition. In some embodiments, the peak temperature of the heating pulse can be greater than or equal to 600 K, for example, greater than or equal to 1000 K (e.g., in a range of 1500-3000 K).

In some embodiments, the pulse of high temperature can be achieved by moving the pellet through a spatially-restricted heating zone (e.g., where duration of the heating is determined by the size of the heating zone and speed of the pellet through the heating zone). Alternatively or additionally, in some embodiments, the pulse of high temperature can be achieved via pulsed operation of a heating element. In some embodiments, the high-temperature heating of process block 230 can be performed in a batch manner, for example, where the composite pellets are conveyed to a heating zone, maintained substantially stationary during exposure to the sintering temperature, and then conveyed out of the heating zone during or after cooling. Alternatively, in some embodiments, the high-temperature heating of process block 230 can be performed in a continuous manner, for example, where the composite pellets are conveyed into and through the heating zone at the same time a heating element provides the peak temperature. In such embodiments, the transit time through the heating zone and operation of the heating element can be coordinated to ensure that each composite pellet passing through the heating zone is exposed to the peak temperature for a cumulative amount of time substantially equivalent to a desired sintering duration (e.g., less than a predetermined maximum time).

The method 220 can proceed to process block 232, where the solid-state ion conductor can be adapted for use in a particular application. For example, in some embodiments, the solid-state ion conductor can be used as an SSE in a solid-state battery. In such applications, process block 232 can include assembling the SSE together with an anode and a cathode to form a battery. In some embodiments, the anode and/or the cathode can be coupled to opposite sides of the SSE. Alternatively or additionally, in some embodiments, the anode and/or the cathode can be integrally formed on a respective surface of the SSE, for example, by sintering a layer directly on the SSE (e.g., as described in International Publication No. WO 2020/236767, published Nov. 26, 2020 and entitled “High temperature sintering systems and methods,” which is incorporated herein by reference).

Although illustrated separately, it is contemplated that various process blocks may occur simultaneously or iteratively. Furthermore, certain process blocks illustrated as occurring after others may indeed occur before. Although some of blocks 224-232 of method 220 have been described as being performed once, in some embodiments, multiple repetitions of a particular process block may be employed before proceeding to the next decision block or process block. In addition, although blocks 224-232 of method 220 have been separately illustrated and described, in some embodiments, process blocks may be combined and performed together (simultaneously or sequentially). Moreover, although FIG. 2B illustrates a particular order for blocks 224-232, embodiments of the disclosed subject matter are not limited thereto. Indeed, in certain embodiments, the blocks may occur in a different order than illustrated or simultaneously with other blocks. In some embodiments, method 220 may comprise only some of blocks 224-232 of FIG. 2B.

### Multi-Stage Sintering Methods

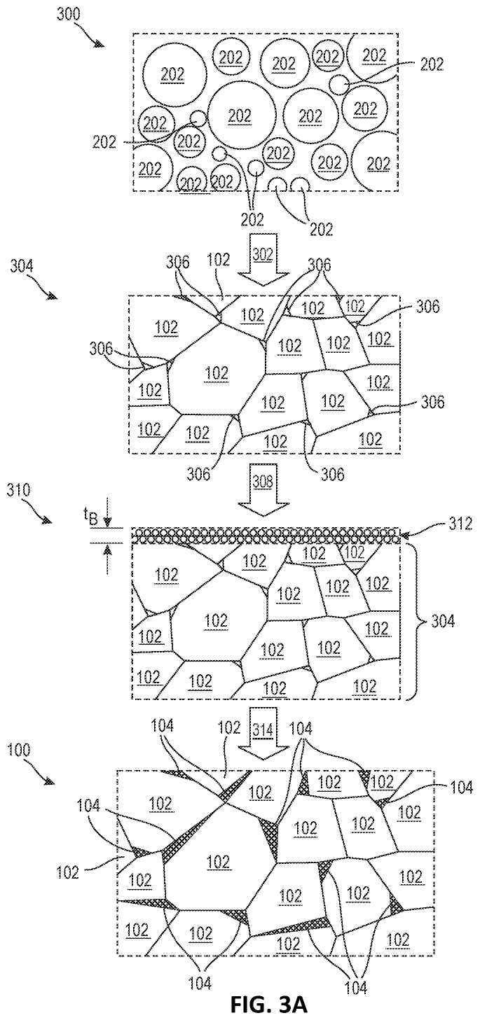

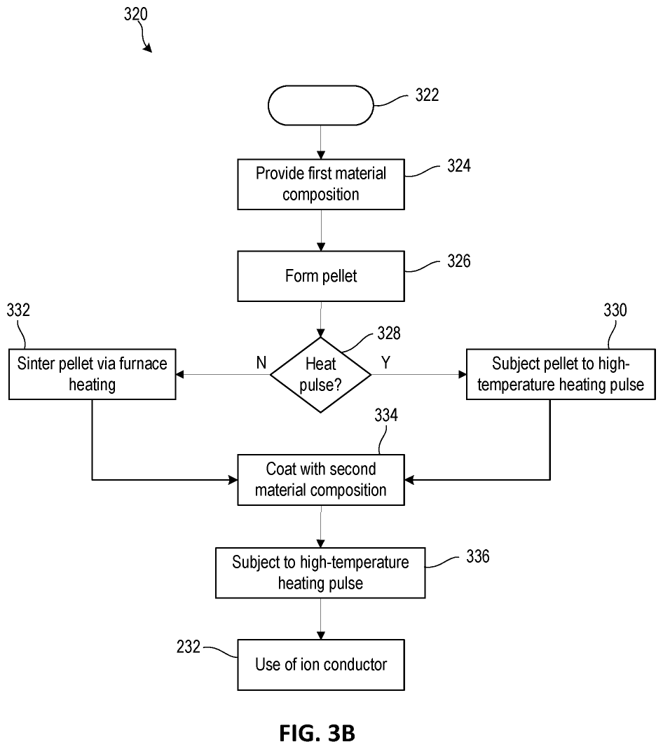

FIG. 3A illustrates aspects of an exemplary multi-stage sintering process. An initial green pellet 300 can be provided, for example, by disposing and/or pressing together a powder. In the illustrated example, the green pellet 300 has a plurality of particles 202 formed by one or more first material compositions (and/or precursors thereof). By subjecting the pellet 300 to sintering 302, the pellet 300 can be converted to a sintered structure 304 (e.g., having a first density) characterized by a plurality of voids 306 between adjacent grains 102 of the first material composition. The sintering 302 can comprise heating at a temperature greater than a sintering temperature of the first material composition, for example, using a conventional furnace (e.g., subjecting to a substantially constant temperature for hours) or via a high-temperature heating pulse (e.g., subjecting to a peak temperature for 60 seconds or less). A thin layer 312 (e.g., having a thickness t₂ in a range of 20-100 μm) of particles formed by one or more second material compositions (and/or precursors thereof) can be provided on a surface of the sintered structure 304, thereby forming a coated structure 310. In some embodiments, the layer 312 can be deposited 308 via any film deposition or coating technique, such as but not limited to physical vapor deposition, chemical deposition, and/or sputtering. In some embodiments, the thickness t₂ of the second material composition layer 312 can be less than or equal to 10% of the thickness of the sintered structure (e.g., thickness t₁). By subjecting the coated structure 310 to a high-temperature heating pulse 314 (e.g., having a duration ≤60 seconds), the structure 310 can be converted to the composite ion-conducting structure 100, for example, by melting layer 312 such that the second material composition infiltrates the voids of the sintered structure 304.

As with the single-stage sintering process, the second material composition can be retained in the final structure because of the short exposure to high temperature. In addition, because the infiltration of the second material composition is decoupled from the sintering of the first material composition, the temperature of the heating pulse 314 for the second material composition can be less than the temperature of the sintering 302 for the first material composition, which temperature decoupling may help to further preserve the second material composition in the final structure. For example, the temperature of the heating pulse 314 can be less than the sintering temperature of the first material composition (e.g., <1100 K), and the temperature of the sintering 302 can be greater or equal to the sintering temperature of the first material composition (e.g., ≥1100 K).

Referring to FIG. 3B, a method 320 for fabricating a composite sintered structure using a multi-stage sintering is shown. The method 320 can initiate at terminal block 322 and proceed to process block 324, where one or more first material compositions (or precursors thereof) can be provided. In some embodiments, the first material composition can be provided in powder form. For example, the provision of process block 324 can include ball-milling and/or calcination. The method 320 can proceed to process block 326, where the powder can be formed into a green pellet. In some embodiments, the green pellet can be formed by pressing and/or molding, such as by using a pelletizing disk or drum. The method 320 can process to decision block 328, where it is determined if the green pellet should be sintered via a high-temperature heating pulse.

If sintering via high-temperature heating pulse is desired, the method 320 can proceed to process block 330, where the green pellet is subjected to one or more high-temperature heating pulses so as to convert the powder of first material composition into a sintered structure. In some embodiments, the heating pulse includes a peak temperature (e.g., second temperature) greater than a sintering temperature of the first material composition for a duration less than or equal to 60 seconds (e.g., 10-20 seconds), after which the heating can be removed and the pellet allowed to cool to ambient temperature, for example, as shown in FIG. 4A and described in further detail below. In some embodiments, the peak temperature of the heating pulse can be greater than or equal to 1000 K, for example, greater than or equal to 1200 K (e.g., in a range of 1500-3000 K).

Alternatively, if sintering via high-temperature heating pulse is not desired, the method 320 can proceed to process block 332, where the green pellet is heated in a furnace so as to convert the powder of first material composition into the sintered structure. In some embodiments, the furnace heating is at a substantially constant temperature (e.g., second temperature) greater than a sintering temperature of the first material composition for a duration of at least 1 hour (e.g., ˜6 hours). In some embodiments, the furnace temperature can be greater than or equal to 1000 K (e.g., ˜1400 K).

From either process block 330 or process block 332, the method 320 can proceed to process block 334, where the sintered structure can be coated with one or more second material compositions. In some embodiments, the coating can be provided on a top surface of the sintered structure. Alternatively or additionally, the coating can be provided on multiple surfaces of the sintered structure, for example, as a conformal coating over some or all exposed surfaces of the sintered structure.

The method 320 can proceed to process block 336, where the sintered structure with coating can be subjected to one or more high-temperature heating pulses so as to convert the structure into a solid-state ion conductor. In some embodiments, the heating pulse includes a peak temperature greater than a melting temperature of the second material composition for a duration less than or equal to 60 seconds, after which the heating can be removed and the pellet allowed to cool to ambient temperature, for example, as shown in FIG. 4A and described in further detail below. In some embodiments, the peak temperature (e.g., first temperature) of the heating pulse can be less than the sintering temperature (e.g., second temperature) of either process block 330 or 332. Alternatively, in some embodiments, the peak temperature of the heating pulse can be greater than a sintering temperature of the first material composition. The method 220 can proceed to process block 232, where the solid-state ion conductor can be adapted for use in a particular application, for example, as described above with respect to FIG. 2B.

In some embodiments, the pulse of high temperature (e.g., process block 330 and/or 336) can be achieved by moving the initial structure through a spatially-restricted heating zone (e.g., where duration of the heating is determined by the size of the heating zone and speed of the structure through the heating zone). Alternatively or additionally, in some embodiments, the pulse of high temperature can be achieved via pulsed operation of a heating element. In some embodiments, the high-temperature heating (e.g., process block 330 and/or 336) can be performed in a batch manner, for example, where the initial structure is conveyed to a heating zone, maintained substantially stationary during exposure to the sintering or peak temperature, and then conveyed out of the heating zone during or after cooling. Alternatively, in some embodiments, the high-temperature heating (e.g., process block 330 and/or 336) can be performed in a continuous manner, for example, where the initial structure is conveyed into and through the heating zone at the same time a heating element provides the corresponding sintering or peak temperature. In such embodiments, the transit time through the heating zone and operation of the heating element can be coordinated to ensure that each structure passing through the heating zone is exposed to the corresponding sintering or peak temperature for a cumulative amount of time substantially equivalent to a desired duration (e.g., less than a predetermined maximum time).

Although illustrated separately, it is contemplated that various process blocks may occur simultaneously or iteratively. Furthermore, certain process blocks illustrated as occurring after others may indeed occur before. Although some of blocks 232, 324-336 of method 320 have been described as being performed once, in some embodiments, multiple repetitions of a particular process block may be employed before proceeding to the next decision block or process block. In addition, although blocks 232, 324-336 of method 320 have been separately illustrated and described, in some embodiments, process blocks may be combined and performed together (simultaneously or sequentially). Moreover, although FIG. 3B illustrates a particular order for blocks 232, 324-336, embodiments of the disclosed subject matter are not limited thereto. Indeed, in certain embodiments, the blocks may occur in a different order than illustrated or simultaneously with other blocks. In some embodiments, method 320 may comprise only some of blocks 232, 324-336 of FIG. 3B.

### High-Temperature Heating Pulse

In any of the disclosed examples, the heating source (e.g., one or more Joule heating elements) can subject the first material composition (e.g., the base or matrix material of the ion-conducting structure) and/or the second material composition (e.g., the sintering aid and/or filler) to one or more high-temperature heating pulses to effective formation of a sintered, composite ion-conducting structure. For example, a controller can control an electrical power source to apply a short-duration current pulse to the Joule heating element that causes the heating element to rapidly increase to the sintering temperature, dwell at the sintering temperature for a predetermined time period, and then rapidly cool from the sintering temperature.

For example, FIG. 4A shows a high-temperature heating pulse profile 400 that can be generated by the heating element to sintering of the first material composition and/or melting of the second material composition to form a composite sintered structure. The high-temperature heating pulse profile 400 can include a short dwell period t₁ (e.g., ≤60 seconds, such as ≤10-20 seconds, inclusive) at or about sintering temperature T_{H} (e.g., at least 600 K, for example, ≥1000 K, such as in a range of 1500-3000 K, inclusive). In some embodiments, the high-temperature heating pulse profile 400 can further include a rapid transition to and/or from the sintering temperature T_{H}, for example, from/to a low temperature T_{L}, such as room temperature (e.g., 20-25° C.) or an elevated ambient temperature (e.g., 100-200° C.)). For example, the high-temperature heating pulse profile 400 can include a rapid heating ramp R_{H} (e.g., ≥10³ K/s, such as 10⁴-10⁵ K/s, inclusive) and/or a rapid cooling ramp R_{C} (e.g., ≥10³ K/s, such as 10⁴-10⁵ K/s, inclusive). Alternatively or additionally, in some embodiments, the heating transition from the low temperature T_{L} to the sintering temperature T_{H} and/or the cooling transition from the sintering temperature T_{H} to the low temperature T_{L} can occur over one to several seconds (e.g., ≤10 seconds, for example, about 3 seconds).

In some embodiment, the high-temperature heating pulse can be provided by Joule heating, microwave heating, laser heating, electron beam heating, spark discharge heating, or any other heating mechanism capable of providing the sintering temperature, heating rate, and/or cooling rate. For example, the systems and methods for providing the high-temperature heating pulse can be similar to those disclosed in International Publication No. WO 2020/236767, published Nov. 26, 2020 and entitled “High temperature sintering systems and methods,” and International Publication No. WO 2022/204494, published Sep. 29, 2022, published Sep. 29, 2022 and entitled “High temperature sintering furnace systems and methods,” both of which are incorporated herein by reference.

In some embodiments, the high-temperature heating pulse can be terminated by conveying the sintered structures out of a heating zone and/or by de-activating, de-energizing, or otherwise terminating operation of the heating elements. Alternatively or additionally, in some embodiments, cooling at the end of a heating pulse can be achieved using one or more passive cooling features (e.g., heat sinks thermally coupled to the heating element and/or sintered structures, etc.), one or more active cooling features (e.g., fluid flow directed at the sintered structures and/or the heater, fluid flow through a heat sink thermally coupled thereto, etc.), or any combination thereof.

### Computer Implementation

FIG. 4B depicts a generalized example of a suitable computing environment 431 in which the described innovations may be implemented, such as but not limited to aspects of method 220, method 320, and/or a controller of furnace system. The computing environment 431 is not intended to suggest any limitation as to scope of use or functionality, as the innovations may be implemented in diverse general-purpose or special-purpose computing systems. For example, the computing environment 431 can be any of a variety of computing devices (e.g., desktop computer, laptop computer, server computer, tablet computer, etc.).

With reference to FIG. 4B, the computing environment 431 includes one or more processing units 435, 437 and memory 439, 441. In FIG. 4B, this basic configuration 451 is included within a dashed line. The processing units 435, 437 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 4B shows a central processing unit 435 as well as a graphics processing unit or co-processing unit 437. The tangible memory 439, 441 may be volatile memory (e.g., registers, cache, RAM), non-volatile memory (e.g., ROM, EEPROM, flash memory, etc.), or some combination of the two, accessible by the processing unit(s). The memory 439, 441 stores software 433 implementing one or more innovations described herein, in the form of computer-executable instructions suitable for execution by the processing unit(s).

A computing system may have additional features. For example, the computing environment 431 includes storage 461, one or more input devices 471, one or more output devices 481, and one or more communication connections 491. An interconnection mechanism (not shown) such as a bus, controller, or network interconnects the components of the computing environment 431. Typically, operating system software (not shown) provides an operating environment for other software executing in the computing environment 431, and coordinates activities of the components of the computing environment 431.

The tangible storage 461 may be removable or non-removable, and includes magnetic disks, magnetic tapes or cassettes, CD-ROMs, DVDs, or any other medium which can be used to store information in a non-transitory way, and which can be accessed within the computing environment 431. The storage 461 can store instructions for the software 433 implementing one or more innovations described herein.

The input device(s) 471 may be a touch input device such as a keyboard, mouse, pen, or trackball, a voice input device, a scanning device, or another device that provides input to the computing environment 431. The output device(s) 471 may be a display, printer, speaker, CD-writer, or another device that provides output from computing environment 431.

The communication connection(s) 491 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

Tantalum-doped lithium lanthanum zirconium oxide (LLZTO) was used as a matrix for a solid-state electrolyte (SSE). Lithium nitride (Li₃N), which is highly Li⁺-conductive but also highly volatile, was used as a filler in the composite SSE. While Li₃N has been used as a solid electrolyte interface (SEI) component or an artificial SEI layer, it has not previously been used as a filler or sintering aid, as it can otherwise be decomposed and evaporated from extended sintering times. To fabricate the composite SSE, a mixture of LLZTO and Li₃N powders were milled together in controlled weight ratios (e.g., 1 wt %). The resulting mixture were then uniaxially pressed into green pellets for subsequent sintering using the above-described pulsed heating approach. The preparation of the composite pellets and subsequent sintering were conducted in an argon-filled glovebox.

Two pieces of carbon felt (e.g., 8×1.5 cm) were fixed on a graphite holder to act as Joule heating elements, and the green composite pellet was disposed between and in contact with the Joule heating elements. The sintering was implemented using an energy input from a DC power supply through the graphite holder to each carbon felt. Each Joule heating element can be quickly ramped (e.g., on the order of seconds or less, for example, within ˜3 seconds) to the sintering temperature via application of an appropriate current waveform from the DC power supply. During the sintering process, the temperature (e.g., ˜1600 K) was maintained for less than a minute (e.g., on the order of tens of seconds, for example, ˜20 seconds) until the pressed composite green pellets on the heating elements became dense. Temperature of the heating elements was determined using optical means (e.g., a visible-near-infrared spectrometer). Power was then removed from the heating elements, thereby allowing the sintered structures (e.g., Li₃N/LLZTO SSE membranes) to quickly cool to room temperature (e.g., on the order of seconds or less, for example, within ˜3 seconds).

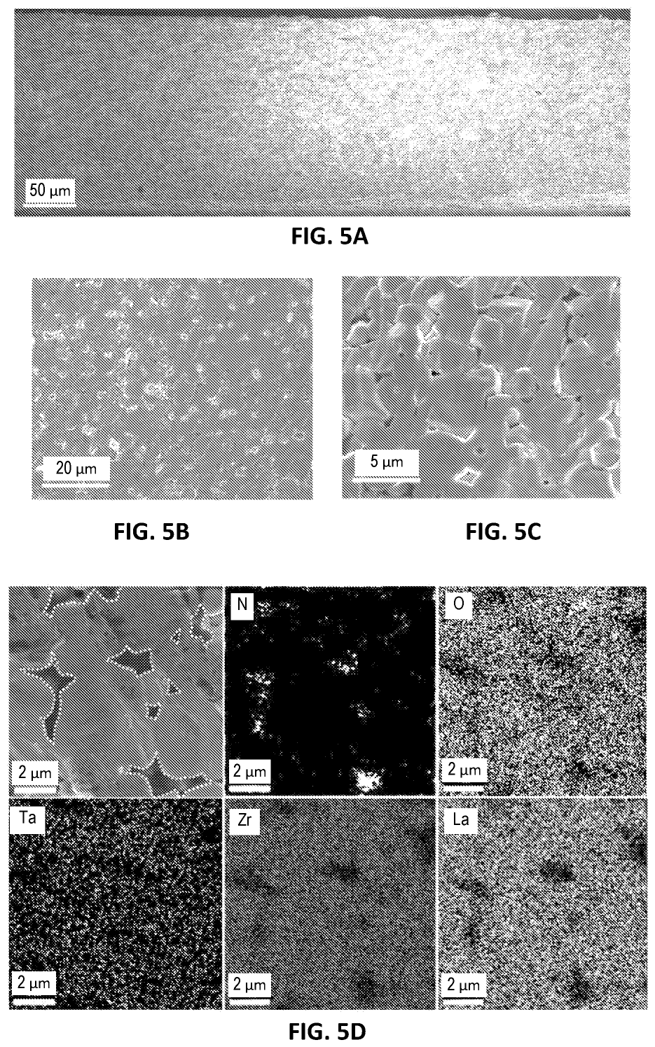

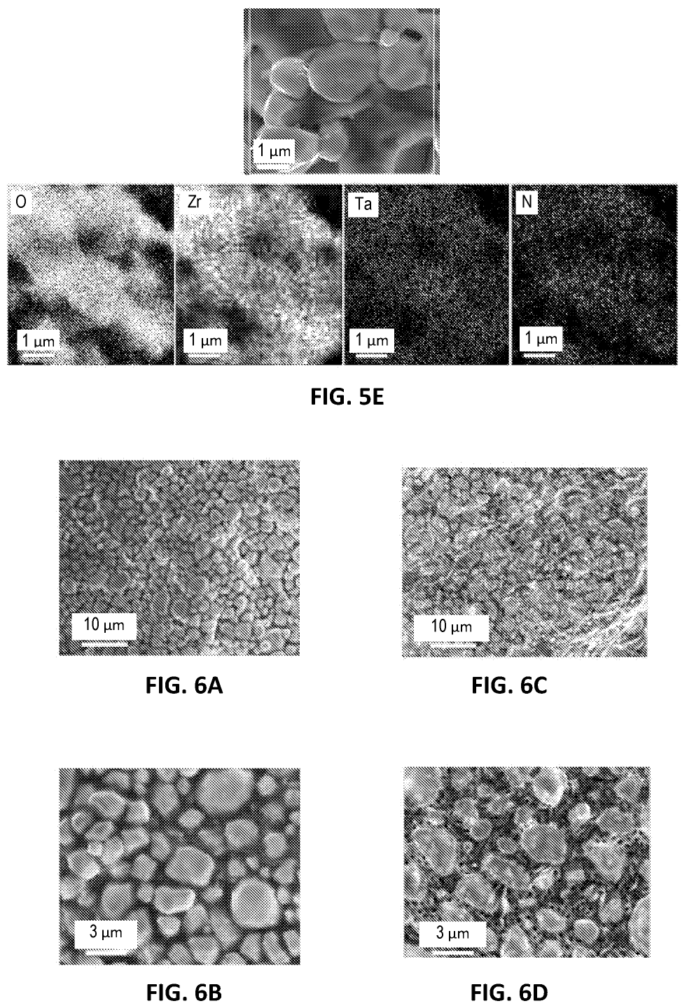

The Li₃N/LLZTO SSE membranes were investigated by scanning electron microscopy (SEM) imaging. As shown in FIG. 5A, the fractured SSE membrane has a highly uniform and dense microstructure throughout its whole cross section. As a result of the sintering, the membrane shrank by 19.8% and 22.5% along its axial (e.g., thickness) and radial directions, respectively, leading to a relative density of 95%, which is slightly higher than a pure LLZTO membrane sintered under the same condition (93%). Despite the shrinkage, the membrane remained flat and smooth without any observable deformation owing to controlled grain growth. A dense microstructure can also be observed in the magnified SEM views of FIGS. 5B-5C. where most grains formed neck bonding with only a few void-like or pinhole-like spots.

To visualize the locations of Li₃N filler within the sintered structure, energy dispersive spectroscopy (EDS) was used to map the elemental distribution of nitrogen (N), oxygen (O), tantalum (Ta), zirconium (Zr), and lanthanum (La) on a selected spot of the fractured Li₃N/LLZTO SSE membrane, the results of which are shown in FIG. 5D. The N elemental map shows that the Li₃N filler primarily distributed in the voids, gaps, and pinholes between LLZTO grains. In addition, while the O elemental map overlaps with those of Ti, Zr, and La belonging to the LLZTO component, they do not overlap with the N elemental map, thus indicating little cross-diffusion. As shown in FIG. 5E, the liquid phase of Li₃N conformally wets the grains of the LLZTO during sintering. The elemental maps of O, Ti, Zr, and La also overlap with each other, and so does the elemental map of N, as the signal intensity generally follows the height profile of the sample, especially on an unpolished non-flat surface. These results indicate that the Li₃N filler distributed among the voids, gaps, and pinholes, as well as coated the surface of the LLZTO grains.

As previously noted, the incorporation of the highly-volatile Li₃N filler was unattainable using conventional furnace sintering. To illustrate this, a composite green pellet (made by the same process described above) was sintered using a furnace at 1150° C. (1423 K) for 6 hours. While the microstructure of the resulting sintered pellet was found to be comparably dense (˜93% relative density), the elemental mapping results showed almost no N signal, indicating substantial loss of Li₃N during the prolonged exposure to high temperature required by the conventional sintering process.

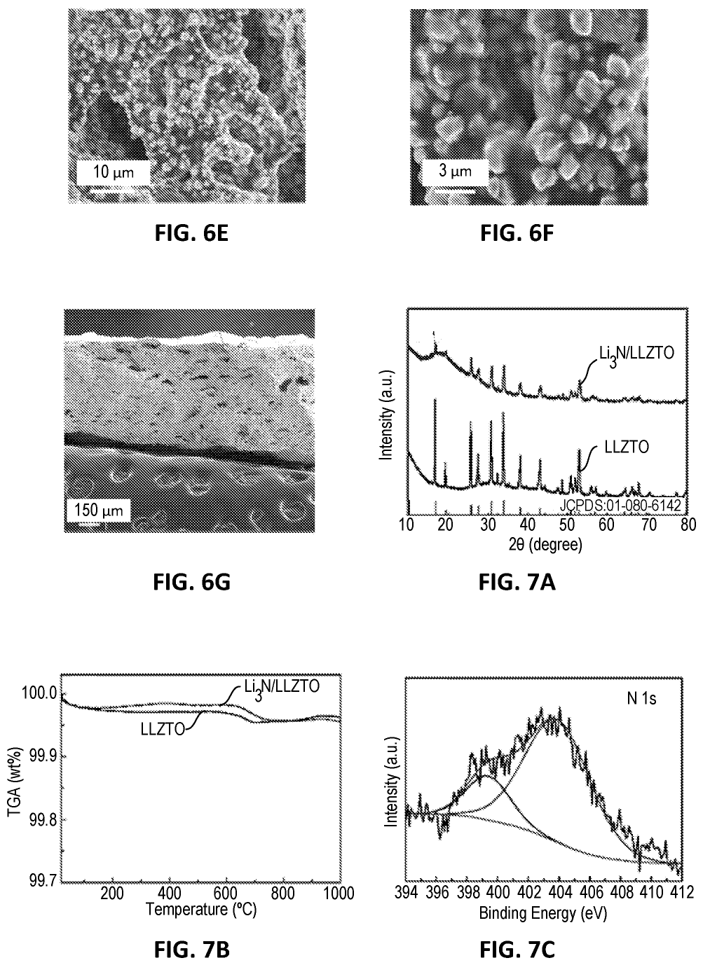

Sintered pellets containing different loading of Li₃N filler was performed, in particular, for filler loading ranging from 2-5 wt %. As shown in the SEM images of FIGS. 6A-6G, the Li₃N/LLZTO SSE membranes exhibited an increase in thickness of grain boundaries as the Li₃N filler loading increased (e.g., due to increased Li₃N aggregates between the grains of LLZTO), and eventually a porous microstructure (e.g., due to the loss of excess amounts of Li₃N) at the highest loading). Although the segregated LLZTO grains resulting from a 2 wt % Li₃N filler loading may be less favorable for some applications (e.g., SSE in a battery), this experiment allowed exploration of the loading threshold (e.g., ˜5 wt %) of the Li₃N filler to maintain a dense microstructure using the disclosed high-temperature pulsed heating techniques for sintering.

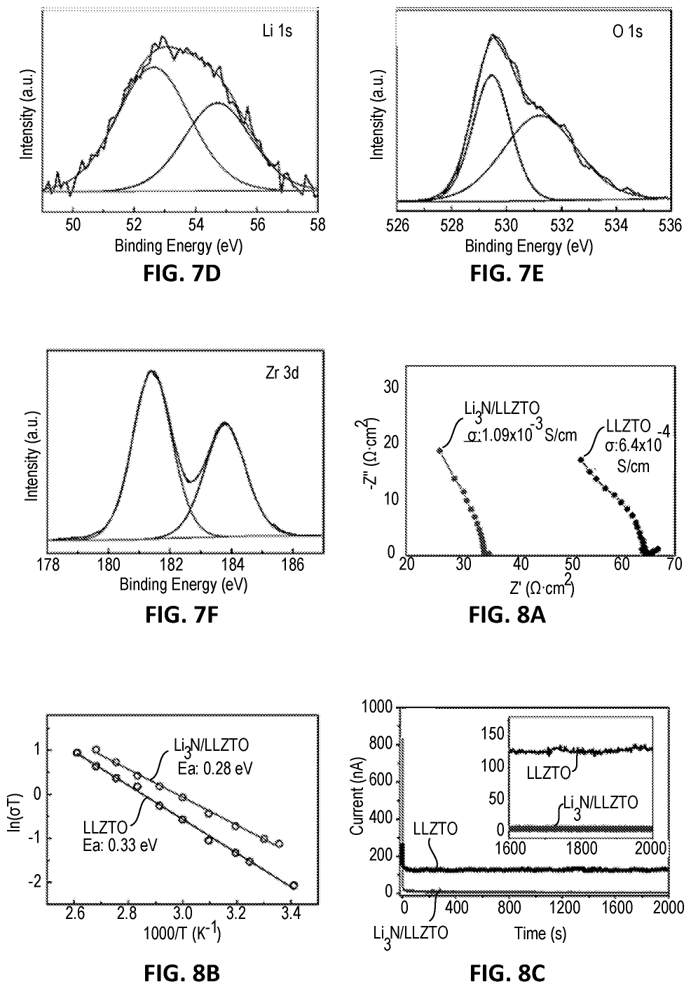

The physiochemical properties of the Li₃N/LLZTO SSE membranes synthesized via the disclosed high-temperature pulsed heating techniques were examined. In particular, X-ray diffraction (XRD) was carried out for LLZTO membranes with and without the Li₃N filler. As shown in FIG. 7A, both XRD patterns agree with the desired cubic phase of LLZTO (JCPDS: 01-080-6142), suggesting successful synthesis from powders to a membrane. Li₃N was not observed by XRD for the Li₃N/LLZTO composite SSE membrane, likely due to the low amount. The LLZTO membranes with and without the Li₃N filler sintered via the disclosed high-temperature pulsed heating techniques were also characterized by thermogravimetric analysis (TGA). Due to the dense microstructure where Li₃N is well trapped, no obvious difference can be observed by comparing the two membranes, as shown in FIG. 7B.

X-ray photoelectron spectroscopy (XPS) was also conducted for the Li₃N/LLZTO composite SSE membrane with respect to various elements. As shown in FIG. 7C, the deconvoluted N 1 s spectrum shows a major peak and a minor peak, which was attributed to the Li₃N filler and its potential interaction with the LLZTO matrix. In addition, the inevitable air exposure during sample transfer for the XPS measurement could contaminate the sample that further complicates the data analysis. Despite the artifacts, the broad peak centered at 403 eV is likely composed of N—H and N—O species, while the other small peak centered at 398.5 eV originated from Li₃N fillers. The deconvoluted Li 1 s spectrum in FIG. 7D is consistent with the electronic states of Li in both LLZTO and Li₃N. The O 1 s spectrum in FIG. 7E shows a minor peak with binding energy at 529.2 eV associated with the structural oxygen, and a major peak with binding energy at 531.3 eV associated with the absorbed O₂ from the environment The Zr 3d spectrum in FIG. 7F exhibits two deconvoluted peaks, which can be attributed to Zr⁴⁺ 3d_{3/2} at 183.8 eV and Zr⁴⁺ 3d_{5/2} at 181.4 eV respectively.

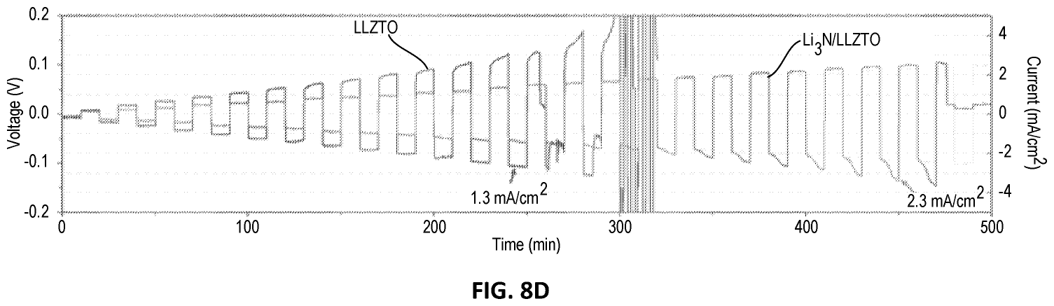

As discussed above, the Li₃N fills the voids, gaps and pinholes, as well as coats the grains of LLZTO, which can improve the electrochemical properties of the SSE membrane. To characterize the performance of the Li₃N/LLZTO composite structure as a solid-state electrolyte, as compared to the filler-less LLZTO structure, a symmetric cell configuration was used. In particular, a Li|Li₃N/LLZTO|Li symmetric cell was assembled by coating Li metal on opposite sides of a Li₃N/LLZTO composite electrolyte. Electrochemical impedance spectroscopy (EIS) was measured at a frequency range from 100 mHz to 1 MHz with an amplitude of 10 mV. Li⁺ conductivity of the composite SSE was calculated according to the equation σ=D/(A×R), where D is the thickness, A is the area, and R is the resistance of the SSE. Galvanostatic charging/discharging of the Li|Li₃N/LLZTO|Li symmetric cell was performed at different current densities with a step size of 30 mins. The measurements were performed in an argon-filled glovebox at room temperature. As illustrated in FIG. 8A, the EIS revealed a decrease of areal specific resistance (ASR) from 63 to 35 Ω·cm² and an increase of ionic conductivity from 6.4×10⁻⁴ to 1.09×10⁻³ S/cm at 298 K after incorporating the Li₃N filler with LLZTO. The activation energy (Eₐ) of Li⁺ conduction for the Li₃N/LLZTO was then measured to be 0.28 eV from 298 K to 373 K according to the Arrhenius law, which was 0.05 eV lower than that of the pure LLZTO, as shown in FIG. 8B.

In addition to the ionic conductivity, another key factor for the overall performance of a SSE membrane is the electronic conductivity, which was found to have an impact on the Li dendritic growth and penetration. FIG. 8C shows the current-time profiles of the SSE membranes with and without the Li₃N filler, which were measured using the blocking electrode method under DC polarization. In particular, DC polarization was performed on a blocking electrode under a constant voltage of 1 V. Silver (Ag) paste was coated on both sides of the composite SSE and the Ag/electrolyte membrane/Ag was preheated at 200° C. for 30 mins before the DC polarization test. These measurements were performed in an argon-filled glovebox at room temperature. As shown in FIG. 8C, the current first decreases and then plateaus as a result of electrical leak. The electronic conductivities were calculated to be 3.5×10⁻⁸ and 2×10⁻⁹ S/cm at 298 K for LLZTO and Li₃N/LLZTO respectively. The electronic conductivity decreased by over an order of magnitude after incorporating Li₃N filler, which suppresses the dendrite penetration and benefits the cycling stability.

The critical current density (CCD) using a rate increment of 0.1 mA/cm² and a duration of 10 minutes was measured. As shown in FIG. 8D, the Li|Li₃N/LLZTO|Li symmetric cell shows a much more stable performance and smaller overpotential compared with the Li|LLZTO|Li symmetric cell. The CCD values were 1.3 and 2.3 mA/cm² for the Li|LLZTO|Li and the Li|Li₃N/LLZTO|Li symmetric cells, respectively, suggesting the critical role played by the Li₃N filler and the successful incorporation via the disclosed high-temperature heating pulse approach.

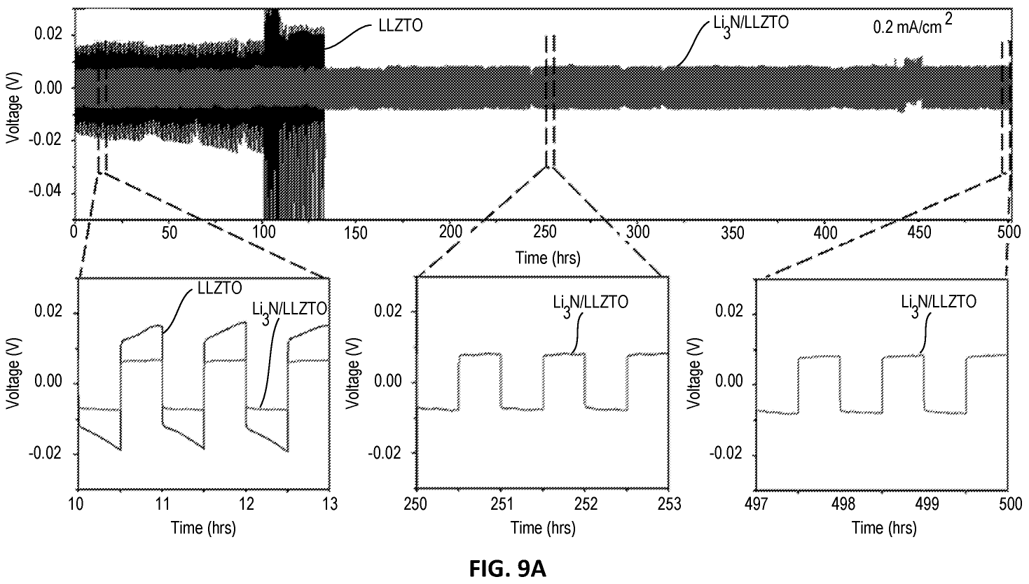

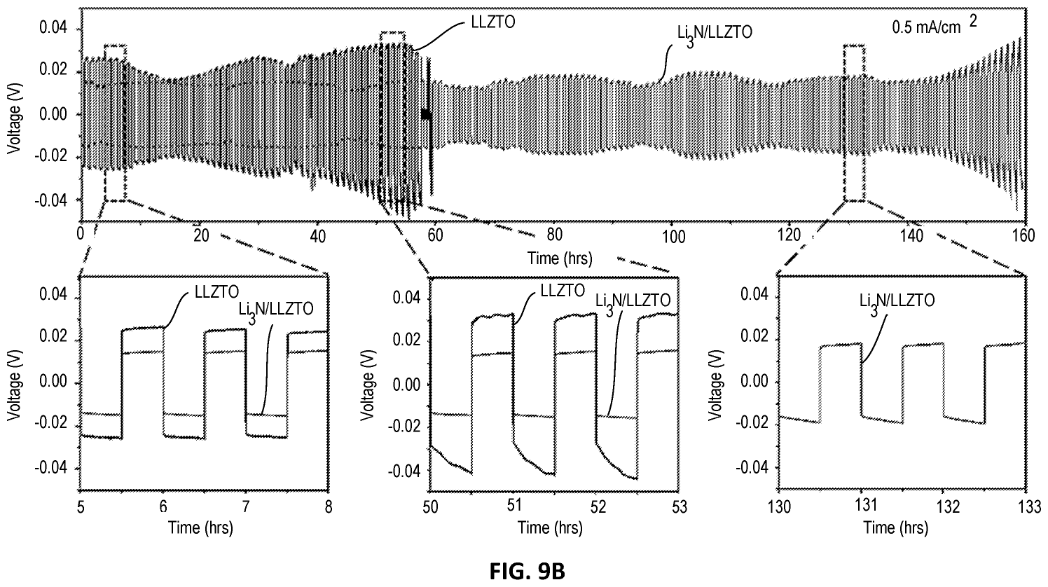

The Li|LLZTO|Li and Li|Li₃N/LLZTO|Li cells were further tested under galvanostatic conditions to compare their longtime cycling stability. Using a current density of 0.2 mA/cm² with an areal capacity of 0.1 mAh/cm², the Li|Li₃N/LLZTO|Li cell demonstrated stable operation for 500 hours, as shown in FIG. 9A. The magnified views show small overpotentials of only ˜8 mV, indicating facile Li plating and stripping processes. In comparison, the Li|LLZTO|Li symmetric cell showed a gradually increased overpotential and eventually shorted after ˜100 hours of cycling operation, as also shown in FIG. 9A. In FIG. 9B, when testing with a larger current density of 0.5 mA/cm² and an areal capacity of 0.25 mAh/cm², the Li|Li₃N/LLZTO|Li cell still outperformed the LLZTO membrane in terms of cycling stability and overpotential. In particular, despite of the fluctuations in the voltage profile, the Li|Li₃N/LLZTO|Li demonstrated a stable cycling performance for up to 150 hours, in comparison with only 55 hours for the Li|LLZTO|Li cell. Accordingly, the effective incorporation of the highly-volatile Li₃N filler into the composite SSE via the disclosed high-temperature heating pulse method can improve the relative density, ionic conductivity, and electrical resistivity, thereby offering better CCD and cycling performance of the corresponding solid-state battery.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A solid-state ion-conducting structure comprising:
a plurality of grains formed of a first material composition; and
a second material composition different from the first material composition,
wherein the second material composition (i) wets boundaries of the plurality of grains, (ii) fills voids between adjacent grains, or (iii) both (i) and (ii),
wherein each of the first and second material compositions has an ionic conductivity greater than or equal to approximately 1×10⁻⁴ S/cm,
a melting point of the first material composition greater than or equal to a first temperature, and
a melting point of the second material composition being less than the first temperature.

Clause 2. The solid-state ion-conducting structure of any clause or example herein, in particular, Clause 1, wherein the ionic conductivity of the second material composition is greater than or equal to 1×10⁻³ S/cm.

Clause 3. The solid-state ion-conducting structure of any clause or example herein, in particular, any one of Clauses 1-2, wherein the second material composition is less than or equal to 5 wt % of the solid-state ion-conducting structure.

Clause 4. The solid-state ion-conducting structure of any clause or example herein, in particular, any one of Clauses 1-3, wherein the second material composition is less than or equal to 2 wt % of the solid-state ion-conducting structure.

Clause 5. The solid-state ion-conducting structure of any clause or example herein, in particular, any one of Clauses 1-4, wherein the second material composition is less than or equal to 1 wt % of the solid-state ion-conducting structure.

Clause 6. The solid-state ion-conducting structure of any clause or example herein, in particular, any one of Clauses 1-5, wherein:
(a1) the first material composition has an electronic conductivity less than or equal to 10⁻⁸ S/cm;
(b1) the second material composition has an electronic conductivity less than or equal to 10⁻¹¹ S/cm; or
both (a1) and (b1).

Clause 7. The solid-state ion-conducting structure of any clause or example herein, in particular, any one of Clauses 1-6, wherein:
(a2) the first material composition has an electronic conductivity less than or equal to 10⁻⁹ S/cm;
(b2) the second material composition has an electronic conductivity less than or equal to 10⁻¹² S/cm; or
both (a2) and (b2).

Clause 8. The solid-state ion-conducting structure of any clause or example herein, in particular, any one of Clauses 1-7, wherein the first temperature is approximately 1200 K. Clause 9. The solid-state ion-conducting structure of any clause or example herein, in particular, any one of Clauses 1-8, wherein a mean grain size of the plurality of grains is approximately 10 μm or less.

Clause 10. The solid-state ion-conducting structure of any clause or example herein, in particular, any one of Clauses 1-9, wherein an areal specific resistance of the solid-state ion-conducting structure is less than or equal to 50 Ω·cm².

Clause 11. The solid-state ion-conducting structure of any clause or example herein, in particular, any one of Clauses 1-10, wherein an areal specific resistance of the solid-state ion-conducting structure is approximately 35 Ω·cm².

Clause 12. The solid-state ion-conducting structure of any clause or example herein, in particular, any one of Clauses 1-11, wherein an electrochemical stability window of the solid-state ion-conducting structure is at least 4 V.

Clause 13. The solid-state ion-conducting structure of any clause or example herein, in particular, any one of Clauses 1-12, wherein a mechanical strength of the solid-state ion-conducting structure is at least 10 MPa.

Clause 14. The solid-state ion-conducting structure of any clause or example herein, in particular, any one of Clauses 1-13, wherein the melting point of the second material composition is in a range of 500-1100 K, inclusive.

Clause 15. The solid-state ion-conducting structure of any clause or example herein, in particular, any one of Clauses 1-14, wherein:
(a3) the first material composition comprises lithium;
(b3) the second material composition comprises lithium; or
both (a3) and (b3).

Clause 16. The solid-state ion-conducting structure of any clause or example herein, in particular, any one of Clauses 1-15, wherein the second material composition is an inorganic metal salt or a non-oxide metal salt.

Clause 17. The solid-state ion-conducting structure of any clause or example herein, in particular, any one of Clauses 1-16, wherein the second material composition comprises LiCl, LiBr, LiI, LiF, Li₃N, LiBH₄, LiBF₄, or any combination of the foregoing.

Clause 18. The solid-state ion-conducting structure of any clause or example herein, in particular, any one of Clauses 1-17, wherein:
the first material composition comprises a compound having a formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F};
where 4<A<8.5, 1.5<B<4, 0≤C≤2, 0≤D≤2, 0≤E<2, and 10<F<13,
M′ is a first one selected from Al, Mo, W, Nb, Sb, Ca, Ba, Sr, Ce, Hf, Rb, or Ta, and
M″ is a second one selected from Al, Mo, W, Nb, Sb, Ca, Ba, Sr, Ce, Hf, Rb, or Ta.

Clause 19. The solid-state ion-conducting structure of any clause or example herein, in particular, any one of Clauses 1-17, wherein:
the first material composition comprises a compound having a formula of Li_{A}La_{B}Zr_{C}Al_{D}M′″_{E}O_{F},
where 5<A<7.7, 2<B<4, 0<C≤2.5, 0≤D<2, 0≤E<2, and 10<F<13, and
M′″ is Nb, Ta, V, W, Mo, or Sb.

Clause 20. The solid-state ion-conducting structure of any clause or example herein, in particular, any one of Clauses 1-19, wherein the first material composition comprises perovskite-type Li₃ₓLa_{2/3-x}TiO₃, NASICON-type Li_{1.3}Al_{0.3}Ti_{1.7}(PO₄)₃, NASICON-type Li₁₊ₓAlₓGe₂₋ₓ(PO₄)₃, garnet-type Li₇La₃Zr₂O₁₂ (LLZO), garnet-type Li₇La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, anti-perovskite-type Li₃OCl, or any combination of the foregoing, wherein x represents a number.

Clause 21. The solid-state ion-conducting structure of any clause or example herein, in particular, any one of Clauses 1-20, wherein the first material composition is garnet-type Li₇La₃Zr_{1.4}Ta_{0.6}O₁₂ (LLTZO) and the second material composition is Li₃N.

Clause 22. The solid-state ion-conducting structure of any clause or example herein, in particular, any one of Clauses 1-21, wherein the solid-state ion-conducting structure is constructed as a solid-state electrolyte.

Clause 23. The solid-state ion-conducting structure of any clause or example herein, in particular, any one of Clauses 1-22, wherein the solid-state ion-conducting structure is constructed to conduct alkali metal ions, anions, or both.

Clause 24. The solid-state ion-conducting structure of any clause or example herein, in particular, any one of Clauses 1-23, wherein the solid-state ion-conducting structure is constructed to conduct lithium ions, sodium ions, potassium ions, oxygen ions, or any combination of the foregoing.

Clause 25. The solid-state ion-conducting structure of any clause or example herein, in particular, any one of Clauses 1-24, wherein a relative density of the solid-state ion-conducting structure is greater than 93%.

Clause 26. A battery comprising an anode, a cathode, and a solid-state electrolyte separating the anode from the cathode, the solid-state electrolyte comprising the solid-state ion-conducting structure of any clause or example herein, in particular, any one of Clauses 1-25.

Clause 27. The battery of any clause or example herein, in particular, Clause 26, wherein the anode is a lithium anode.

Clause 28. The battery of any clause or example herein, in particular, any one of Clauses 26-27, wherein the anode consists essentially of lithium.

Clause 29. The battery of any clause or example herein, in particular, any one of Clauses 26-28, wherein the battery exhibits a critical current density of at least 2 mA/cm².

Clause 30. A method comprising:
providing a first powder comprising a first material composition or one or more first precursors of the first material composition, a melting point of the first material composition being greater than or equal to a first temperature;
providing a second powder comprising a second material composition or one or more second precursors of the second material composition, the second material composition being different from the first material composition, a melting point of the second material composition being less than the first temperature;
forming a composite pellet by at least mixing the first and second powders together; and
subjecting the composite pellet to a high-temperature heating pulse so as to convert the composite pellet into a solid-state ion-conducting structure, the high-temperature heating pulse comprising exposure to a first sintering temperature of at least 600 K for a duration less than or equal to 60 seconds,
wherein, within the solid-state ion-conducting structure, the second material composition (i) wets boundaries of a plurality of grains formed by the first material composition, (ii) fills voids between adjacent grains formed by the first material composition, or (iii) both (i) and (ii), and
each of the first and second material compositions has an ionic conductivity greater than or equal to approximately 1×10⁻⁴ S/cm.

Clause 31. A method comprising:
providing an initial pellet comprising a first material composition or one or more first precursors of the first material composition, a melting point of the first material composition being greater than or equal to a first temperature;
heating the initial pellet at a second sintering temperature to form a sintered structure comprising a plurality of grains formed by the first material composition;
coating a surface of the sintered structure with a second material composition or one or more second precursors of the second material composition, the second material composition being different from the first material composition, a melting point of the second material composition being less than the first temperature;
subjecting the coated sintered structure to a high-temperature heating pulse so as to convert the coated sintered structure into a solid-state ion-conducting structure, the high-temperature heating pulse comprising exposure to a first sintering temperature of at least 600 K for a duration less than or equal to 60 seconds,
wherein, within the solid-state ion-conducting structure, the second material composition (i) wets boundaries of the plurality of grains, (ii) fills voids between adjacent grains, or (iii) both (i) and (ii), and
each of the first and second material compositions has an ionic conductivity greater than or equal to approximately 1×10⁻⁴ S/cm.

Clause 32. The method of any clause or example herein, in particular, Clause 31, wherein a thickness of the coating on the surface of the sintered structure is about 10% of a thickness of the sintered structure.

Clause 33. The method of any clause or example herein, in particular, any one of Clauses 31-32, wherein the heating the initial pellet at the second sintering temperature comprises subjecting the initial pellet to another high-temperature heating pulse so as to convert the initial pellet into a sintered structure, the another high-temperature heating pulse comprising exposure to the second sintering temperature for a duration of less than or equal to 60 seconds, the second sintering temperature being greater than the first sintering temperature.

Clause 34. The method of any clause or example herein, in particular, any one of Clauses 31-33, wherein the second sintering temperature is in a range of 1500-3000 K, inclusive.

Clause 35. The method of any clause or example herein, in particular, any one of Clauses 31-34, wherein the duration of the another high-temperature heating pulse is in a range of 10-20 seconds, inclusive.

Clause 36. The method of any clause or example herein, in particular, any one of Clauses 30-35, wherein a relative density of the solid-state ion-conducting structure is greater than 93%.

Clause 37. The method of any clause or example herein, in particular, any one of Clauses 30-36, wherein the duration of the high-temperature heating pulse is in a range of 10-20 seconds, inclusive.

Clause 38. The method of any clause or example herein, in particular, any one of Clauses 30-37, wherein the first sintering temperature is greater than or equal 1200 K.

Clause 39. The method of any clause or example herein, in particular, any one of Clauses 30-38, wherein the first sintering temperature is in a range of 1500-3000 K, inclusive.

Clause 40. The method of any clause or example herein, in particular, any one of Clauses 30-39, wherein the subjecting to the high-temperature heating pulse comprises heating to the first sintering temperature at a heating rate of at least 10³ K/s.

Clause 41. The method of any clause or example herein, in particular, any one of Clauses 30-40, wherein the subjecting to the high-temperature heating pulse comprises heating to the first sintering temperature at a heating rate in a range of 10³ to 10⁵ K/s, inclusive.

Clause 42. The method of any clause or example herein, in particular, any one of Clauses 30-41, wherein the subjecting to the high-temperature heating pulse comprises cooling from the first sintering temperature at a cooling rate of at least 10³ K/s.

Clause 43. The method of any clause or example herein, in particular, any one of Clauses 30-42, wherein the subjecting to the high-temperature heating pulse comprises cooling from the first sintering temperature at a cooling rate in a range of 10³ to 10⁵ K/s, inclusive.

Clause 44. The method of any clause or example herein, in particular, any one of Clauses 30-43, further comprising:
forming or disposing electrodes on opposite surfaces of the solid-state ion-conducting structure so as to form a battery, the solid-state ion-conducting structure being a solid-state electrolyte.

Clause 45. The method of any clause or example herein, in particular, Clause 44, wherein one of the electrodes comprises a lithium anode.

Clause 46. The method of any clause or example herein, in particular, any one of Clauses 30-45, wherein the ionic conductivity of the second material composition is greater than or equal to 1×10⁻³ S/cm.

Clause 47. The method of any clause or example herein, in particular, any one of Clauses 30-46, wherein the second material composition is less than or equal to 5 wt % of the solid-state ion-conducting structure.

Clause 48. The method of any clause or example herein, in particular, any one of Clauses 30-47, wherein the second material composition is less than or equal to 2 wt % of the solid-state ion-conducting structure.

Clause 49. The method of any clause or example herein, in particular, any one of Clauses 30-48, wherein the second material composition is less than or equal to 1 wt % of the solid-state ion-conducting structure.

Clause 50. The method of any clause or example herein, in particular, any one of Clauses 30-49, wherein:
(a1) the first material composition has an electronic conductivity less than or equal to 10⁻⁸ S/cm;
(b1) the second material composition has an electronic conductivity less than or equal to 10⁻¹¹ S/cm; or
both (a1) and (b1).

Clause 51. The method of any clause or example herein, in particular, any one of Clauses 30-50, wherein:
(a2) the first material composition has an electronic conductivity less than or equal to 10⁻⁹ S/cm;
(b2) the second material composition has an electronic conductivity less than or equal to 10⁻¹² S/cm; or
both (a2) and (b2).

Clause 52. The method of any clause or example herein, in particular, any one of Clauses 30-51, wherein the first temperature is approximately 1200 K.

Clause 53. The method of any clause or example herein, in particular, any one of Clauses 30-52, wherein a mean grain size of the plurality of grains is approximately 10 μm or less.

Clause 54. The method of any clause or example herein, in particular, any one of Clauses 30-53, wherein the melting point of the second material composition is in a range of 500-1100 K, inclusive.

Clause 55. The method of any clause or example herein, in particular, any one of Clauses 30-54, wherein:
(a3) the first material composition comprises lithium;
(b3) the second material composition comprises lithium; or
both (a3) and (b3).

Clause 56. The method of any clause or example herein, in particular, any one of Clauses 30-55, wherein the second material composition is an inorganic metal salt or a non-oxide metal salt.

Clause 57. The method of any clause or example herein, in particular, any one of Clauses 30-56, wherein the second material composition comprises LiCl, LiBr, LiI, LiF, Li₃N, LiBH₄, LiBF₄, or any combination of the foregoing.

Clause 58. The method of any clause or example herein, in particular, any one of Clauses 30-57, wherein:

the first material composition comprises a compound having a formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F};
where 4<A<8.5, 1.5<B<4, 0≤C≤2, 0≤D≤2, 0≤E<2,and 10<F<13,
M′ is a first one selected from Al, Mo, W, Nb, Sb, Ca, Ba, Sr, Ce, Hf, Rb, or Ta, and
M″ is a second one selected from Al, Mo, W, Nb, Sb, Ca, Ba, Sr, Ce, Hf, Rb, or Ta.

Clause 59. The method of any clause or example herein, in particular, any one of Clauses 30-57, wherein:
the first material composition comprises a compound having a formula of Li_{A}La_{B}Zr_{C}Al_{D}M′″_{E}O_{F},
where 5<A<7.7, 2<B<4, 0<C≤2.5, 0≤D<2, 0≤E<2, and 10<F<13, and
M′″ is Nb, Ta, V, W, Mo, or Sb.

Clause 60. The method of any clause or example herein, in particular, any one of Clauses 30-59, wherein the first material composition comprises perovskite-type Li₃ₓLa_{2/3-x}TiO₃, NASICON-type Li_{1.3}Al_{0.3}Ti_{1.7}(PO₄)₃, NASICON-type Li₁₊ₓAlₓGe₂₋ₓ(PO₄)₃, garnet-type Li₇La₃Zr₂O₁₂ (LLZO), garnet-type Li₇La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, anti-perovskite-type Li₃OCl, or any combination of the foregoing, wherein x represents a number.

Clause 61. The method of any clause or example herein, in particular, any one of Clauses 30-60, wherein the first material composition is garnet-type Li₇La₃Zr_{1.4}Ta_{0.6}O₁₂ (LLTZO) and the second material composition is Li₃N.

Clause 62. The method of any clause or example herein, in particular, any one of Clauses 30-61, wherein the solid-state ion-conducting structure conducts alkali metal ions, anions, or both.

Clause 63. The method of any clause or example herein, in particular, any one of Clauses 30-62, wherein the solid-state ion-conducting structure conducts lithium ions, sodium ions, potassium ions, oxygen ions, or any combination of the foregoing.

### Conclusion

Any of the features illustrated or described herein, for example, with respect to FIGS. 1A-9B and Clauses 1-63, can be combined with any other feature illustrated or described herein, for example, with respect to FIGS. 1A-9B and Clauses 1-63 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A solid-state ion-conducting structure comprising:
a plurality of grains formed of a first material composition; and
a second material composition different from the first material composition,
wherein the second material composition (i) wets boundaries of the plurality of grains, (ii) fills voids between adjacent grains, or (iii) both (i) and (ii),
wherein each of the first and second material compositions has an ionic conductivity greater than or equal to approximately 1×10⁻⁴ S/cm,
a melting point of the first material composition greater than or equal to a first temperature, and
a melting point of the second material composition being less than the first temperature.

2. The solid-state ion-conducting structure of claim 1, wherein the ionic conductivity of the second material composition is greater than or equal to 1×10⁻³ S/cm.

3. The solid-state ion-conducting structure of claim 1, wherein the second material composition is less than or equal to 5 wt % of the solid-state ion-conducting structure.

4-5. (canceled)

6. The solid-state ion-conducting structure of claim 1, wherein:
(a1) the first material composition has an electronic conductivity less than or equal to 10⁻⁸ S/cm;
(b1) the second material composition has an electronic conductivity less than or equal to 10⁻¹¹ S/cm; or
both (a1) and (b1).

7-9. (canceled)

10. The solid-state ion-conducting structure of claim 1, wherein an areal specific resistance of the solid-state ion-conducting structure is less than or equal to 50 Ω·cm².

11. (canceled)

12. The solid-state ion-conducting structure of claim 1, wherein an electrochemical stability window of the solid-state ion-conducting structure is at least 4 V.

13. (canceled)

14. The solid-state ion-conducting structure of claim 1, wherein the melting point of the second material composition is in a range of 500-1100 K, inclusive.

15-16. (canceled)

17. The solid-state ion-conducting structure of claim 1, wherein the second material composition comprises LiCl, LiBr, LiI, LiF, Li₃N, LiBH₄, LiBF₄, or any combination of the foregoing.

18. The solid-state ion-conducting structure of claim 1, wherein:
the first material composition comprises a compound having a formula of Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F};
where 4<A<8.5, 1.5<B<4, 0≤C<32, 0≤D≤2, 0≤E<2, and 10<F<13,
M′ is a first one selected from Al, Mo, W, Nb, Sb, Ca, Ba, Sr, Ce, Hf, Rb, or Ta, and
M″ is a second one selected from Al, Mo, W, Nb, Sb, Ca, Ba, Sr, Ce, Hf, Rb, or Ta.

19. The solid-state ion-conducting structure of claim 1, wherein:
the first material composition comprises a compound having a formula of Li_{A}La_{B}Zr_{C}Al_{D}M′″_{E}O_{F},
where 5<A<7.7, 2<B<4, 0<C≤2.5, 0≤D<2, 0≤E<2, and 10<F<13, and
M′″ is Nb, Ta, V, W, Mo, or Sb.

20. The solid-state ion-conducting structure of claim 1, wherein the first material composition comprises perovskite-type Li₃ₓLa_{2/3-x}TiO₃, NASICON-type Li_{1.3}Al_{0.3}Ti_{1.7}(PO₄)₃, NASICON-type Li₁₊ₓAlₓGe₂₋ₓ(PO₄)₃, garnet-type Li₇La₃Zr₂O₁₂ (LLZO), garnet-type Li₇La₃Zr_{1.4}Ta_{0.6}O₁₂ (LLTZO), LISICON-type Li₁₄Zn(GeO₄)₄, thio-LISICON-type Li₄₋ₓGe₁₋ₓPₓS₄, argyrodite-type Li₆PS₅Cl, anti-perovskite-type Li₃OCl, or any combination of the foregoing, wherein x represents a number.

21. The solid-state ion-conducting structure of claim 1, wherein the first material composition is garnet-type Li₇La₃Zr_{1.4}Ta_{0.6}O₁₂ (LLTZO) and the second material composition is Li₃N.

22-25. (canceled)

26. A battery comprising:
an anode;
a cathode; and
a solid-state electrolyte separating the anode from the cathode, the solid-state electrolyte comprising a solid-state ion-conducting structure,
wherein the solid-state ion-conducting structure comprises:
a plurality of grains formed of a first material composition; and
a second material composition different from the first material composition,
the second material composition (i) wets boundaries of the plurality of grains, (ii) fills voids between adjacent grains, or (iii) both (i) and (ii),
each of the first and second material compositions has an ionic conductivity greater than or equal to approximately 1×10⁻⁴ S/cm,
a melting point of the first material composition greater than or equal to a first temperature, and
a melting point of the second material composition being less than the first temperature.

27. The battery of claim 26, wherein the anode is a lithium anode.

28. The battery of claim 26, wherein the anode consists essentially of lithium.

29. The battery of claim 26, wherein the battery exhibits a critical current density of at least 2 mA/cm².

30. A method comprising:
providing a first powder comprising a first material composition or one or more first precursors of the first material composition, a melting point of the first material composition being greater than or equal to a first temperature;
providing a second powder comprising a second material composition or one or more second precursors of the second material composition, the second material composition being different from the first material composition, a melting point of the second material composition being less than the first temperature;
forming a composite pellet by at least mixing the first and second powders together; and
subjecting the composite pellet to a high-temperature heating pulse so as to convert the composite pellet into a solid-state ion-conducting structure, the high-temperature heating pulse comprising exposure to a first sintering temperature of at least 600 K for a duration less than or equal to 60 seconds,
wherein, within the solid-state ion-conducting structure, the second material composition (i) wets boundaries of a plurality of grains formed by the first material composition, (ii) fills voids between adjacent grains formed by the first material composition, or (iii) both (i) and (ii), and
each of the first and second material compositions has an ionic conductivity greater than or equal to approximately 1×10⁻⁴ S/cm.

31-37. (canceled)

38. The method of claim 30, wherein the first sintering temperature is greater than or equal 1200 K.

39-43. (canceled)

44. The method of claim 30, further comprising:
forming or disposing electrodes on opposite surfaces of the solid-state ion-conducting structure so as to form a battery, the solid-state ion-conducting structure being a solid-state electrolyte.

45-49. (canceled)

50. The method of claim 30, wherein:
(a1) the first material composition has an electronic conductivity less than or equal to 10⁻⁸ S/cm;
(b1) the second material composition has an electronic conductivity less than or equal to 10⁻¹¹ S/cm; or
both (a1) and (b1).

51-63. (canceled)
